(19) United States
(12) Patent Application Publication
(10) Pub. No.: US 2005/0182923 A1
(43) Pub. Date: Aug. 18, 2005

(54) Method of controlling portable terminal using external memory

(75) Inventor: Dong-Joon Park, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/039,859

(22) Filed: Jan. 24, 2005

(30) Foreign Application Priority Data
Feb. 17, 2004 (KR) 2004-10279
Dec. 31, 2004 (KR) 2004-118150

(51) Int. Cl. G06F 9/00

(52) U.S. Cl. 713/2; 711/115

(57) ABSTRACT

A method of controlling a portable terminal using an external memory, wherein a portable terminal is turned on upon insertion of an external memory while in a power off state. A pre-registered ID associated with the external memory is detected or a password is requested upon power-on. Upon detection of the ID in the external memory or correct entry of the password, the portable terminal is booted.

### CROSS-REFERENCE TO RELATED APPLICATIONS

This application claims the benefit under 35 U.S.C. §119(a) of Korean Patent Application No. 10-2004-0010279 entitled “Method of Controlling Portable Terminal Using External Memory”, filed in the Korean Intellectual Property Office on Feb. 17, 2004, and Korean Patent Application No. 10-2004-0118150, filed in the Korean Intellectual Property Office on Dec. 31, 2004, the entire contents of each are incorporated herein by reference.

### BACKGROUND OF THE INVENTION

1. Field of the Invention

The present invention relates generally to an external memory in a portable terminal. More particularly, the present invention relates to a method of controlling functions of a portable terminal using an external memory.

2. Description of the Related Art

Along with the proliferation of portable terminals, composite portable terminals equipped with diverse functions, in addition to simple voice communication, are being rapidly developed to satisfy user demands. Also, the introduction of commercial wireless networks, rapid evolution of wireless networks, and the widespread use of premium terminals have driven organization of a broad and dynamic contents provider chain. Due to demands for a larger volume of contents in the changed mobile environment, memory size and data charge have become a significant interest to service providers and users.

In compliance with the demand for a larger volume of contents, detachable external memories have recently been adopted in portable terminals having internal memories. However, the existing external memories are confined to data storage as an extra memory.

Accordingly, a need exists for an external memory and terminal control method for providing a larger array of services, including control functions for a device such as a portable terminal.

### SUMMARY OF THE INVENTION

An object of the present invention is to substantially solve at least the above and other problems and disadvantages, and to provide at least the advantages described below. Accordingly, an object of the present invention is to provide a method of controlling functions of a portable terminal using an external memory.

The above objects are achieved by providing a method of controlling a portable terminal using an external memory.

According to one aspect of the present invention, a method of controlling a portable terminal is provided for use with an external memory, wherein a portable terminal is turned on upon insertion of an external memory in a power off state. A pre-registered ID associated with the external memory is then detected upon power-on. Upon detection of the ID in the external memory, the portable terminal is booted.

It is preferred that if the pre-registered ID is not detected, an input of a predetermined password is requested and, if the predetermined password is received, the portable terminal is then booted.

It is also preferred that the portable terminal is turned off if the password is not received.

According to another aspect of the present invention, a method of controlling a portable terminal is provided for use with an external memory, wherein upon a key input after the insertion of an external memory in the portable terminal, it is determined whether a use restriction function has been set. If the use restriction function has been set, it is determined whether the external memory has already been registered. If the external memory has already been registered, the use restriction function is released and an operation associated with the key input is performed.

It is preferred that a user is notified that the operation associated with the key input cannot be performed upon ejection of the external memory.

It is also preferred that if the external memory has not already been registered for providing an ID, input of a predetermined password is requested, and, if the predetermined password is received, an operation associated with the key input is performed.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a portable terminal according to an embodiment of the present invention;

FIG. 2 is a flowchart illustrating an operation for controlling the power of the portable terminal depending on the insertion and ejection of an external memory according to an embodiment of the present invention; and

FIG. 3 is a flowchart illustrating an operation for controlling the use restriction function of the portable terminal according to an embodiment of the present invention.

Throughout the drawings, like reference numerals will be understood to refer to like parts, components and structures.

### DETAILED DESCRIPTION OF THE EXEMPLARY EMBODIMENTS

Exemplary embodiments of the present invention will now be described herein with reference to the accompanying drawings. In the following description, functions or constructions well known to those skilled in the art are not described in detail since they would obscure the invention in unnecessary detail.

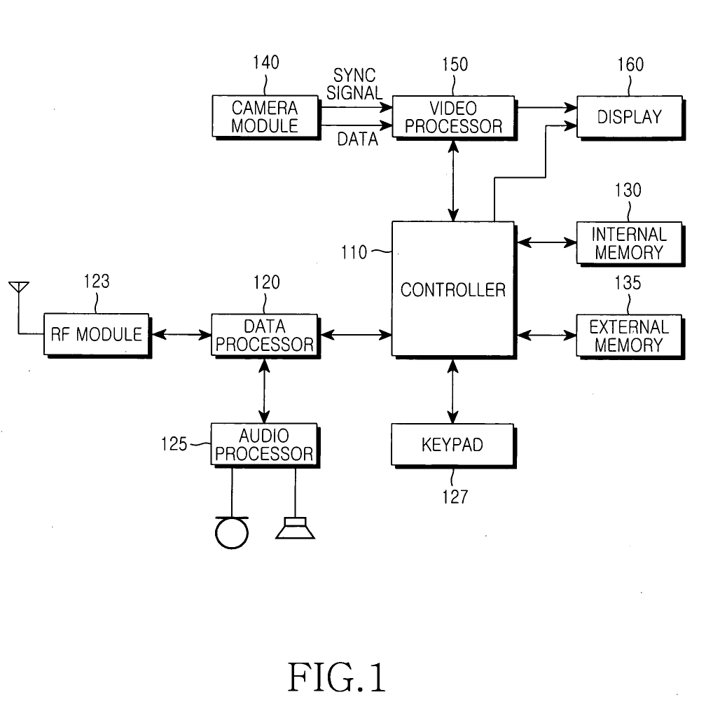

FIG. 1 is a block diagram of a portable terminal equipped with a camera according to an embodiment of the present invention.

Referring to FIG. 1, the portable terminal includes an RF (Radio Frequency) module 123, a data processor 120, an audio processor 125, a keypad 127, a controller 110, an internal memory 130, an external memory 135, a camera module 140, a video processor 150, and a display 160.

The RF module 123 includes an RF transmitter (not shown) for upconverting and amplifying the frequency of a transmission signal, and an RF receiver (not shown) for low-noise-amplifying a received signal and downconverting the signal frequency.

The data processor 120 is provided with a transmitter (not shown) for encoding and modulating the transmission signal, and a receiver (not shown) for demodulating and decoding the received signal. Specifically, the data processor 120 may be configured to include a MODEM and a CODEC. The CODEC includes a data CODEC for processing packet data, and an audio CODEC for processing an audio signal like voice.

The audio processor 125 reproduces the audio signal received from the voice CODEC of the data processor 120, or transmits an audio signal generated from a microphone to the audio CODEC.

The keypad 127 is coupled with the controller 110 and includes keys for inputting digits and characters, and function keys for invoking functions. The function keys can include a Menu key, a Send key, an OK key, a key used to capture an image, and short keys for messages and dialing.

According to an embodiment of the present invention, the portable terminal is provided with the internal memory 130 and the external memory 135. The internal memory 130 can be configured to include a program memory and a data memory. The program memory may store programs for controlling the typical operations of the portable terminal and programs for controlling functions of the portable terminal depending on the insertion or ejection of the external memory 135 according to an embodiment of the present invention. The data memory temporarily stores data generated during execution of the programs.

The external memory 135 can be inserted into and ejected from the portable terminal. It may store a variety of data including MP3 music data, video data, and photo albums. When the external memory 135 is inserted into the portable terminal, the user can selectively retrieve data from the external memory or store data in the external memory.

According to an embodiment of the present invention, the external memory 135 can also include a pre-registered ID (Identifier). The user can set the ID. Specifically, the user registers the unique number of the external memory 135 or a user-selected ID value for the external memory as the ID when the external memory is initially inserted.

The external memory 135 is coupled to a power switch (not shown) when it is inserted into the portable terminal. Thus, the insertion of the external memory 135 can turn on the portable terminal. The external memory 135 including the pre-registered ID, can then release the use restriction function of the portable terminal according to the embodiments of the present invention. Use restrictions include privacy protection, outgoing call restriction, and incoming call restriction.

The controller 110 provides overall control of the portable terminal. The controller 110 may further incorporate the data processor 120 therein.

According to an embodiment of the present invention, upon insertion of the external memory 135 in a power-off state of the portable terminal and followed by a subsequent power-on state, the controller 110 detects the external memory's ID.

Upon detection of the ID, the controller 110 boots the portable terminal and transitions it to an idle mode.

If a key is pressed in the idle state, the controller 110 determines whether the use restriction function has been set in the portable terminal. The key can be a key for entering a digit or character, the Menu key, the Send key, the key designated for capturing an image, the OK key, or a short key for messaging or dialing.

If the use restriction function has been set, the controller 110 determines whether the inserted external memory 135 has already been registered, for example, a memory with a pre-registered ID or a unique number registered).

If the external memory 135 has already been registered, the controller 110 releases the use restriction function and controls an operation corresponding to the pressed key to be performed.

Upon ejection of the external memory 135, the controller 110 may notify the user that the operation cannot be performed through the display 160.

The camera module 140 is provided with a camera sensor for capturing video data and converting the captured optical signal to an electrical signal, and a signal processor for converting the analog video signal received from the camera sensor into digital data. In the exemplary embodiment, the camera sensor can be implemented as a CCD (Charge Coupled Device) sensor, and the signal processor can be implemented as a DSP (Digital Signal Processor). The camera sensor and the signal processor can be incorporated into a single device or separately configured.

The video processor 150 generates display data to display a video signal received from the camera module 140. The video processor 150 processes the video signal frame by frame and outputs the video frame data according to the characteristics and size of the display 160.

The video processor 150 can include a video CODEC for compressing the video frame data in a predetermined method or for recovering the compressed video frame data into the original video frame data. The video CODEC can be a JPEG CODEC, an MPEG4 CODEC, or a Wavelet CODEC. The video processor 150 can further support OSD (On Screen Display) functionality in the exemplary embodiment, and outputs OSD data according to the size of the screen under the control of the controller 110.

The display 160 can be an LCD (Liquid Crystal Display). The display 160 displays display data generated in the portable terminal under the control of the controller 110. It displays the video signal received from the video processor 150 and user data received from the controller 110. If the LCD is implemented as a touch screen, it may further function as a keypad.

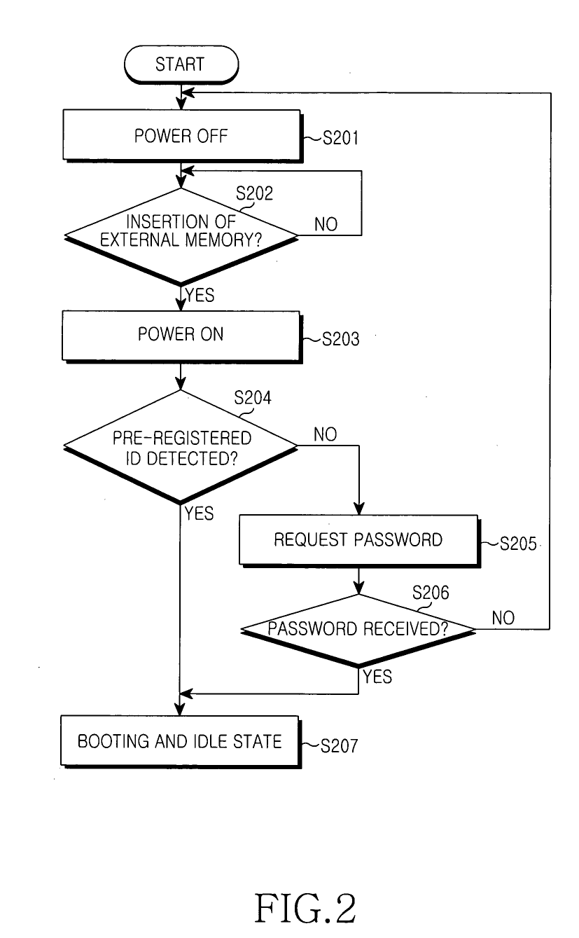

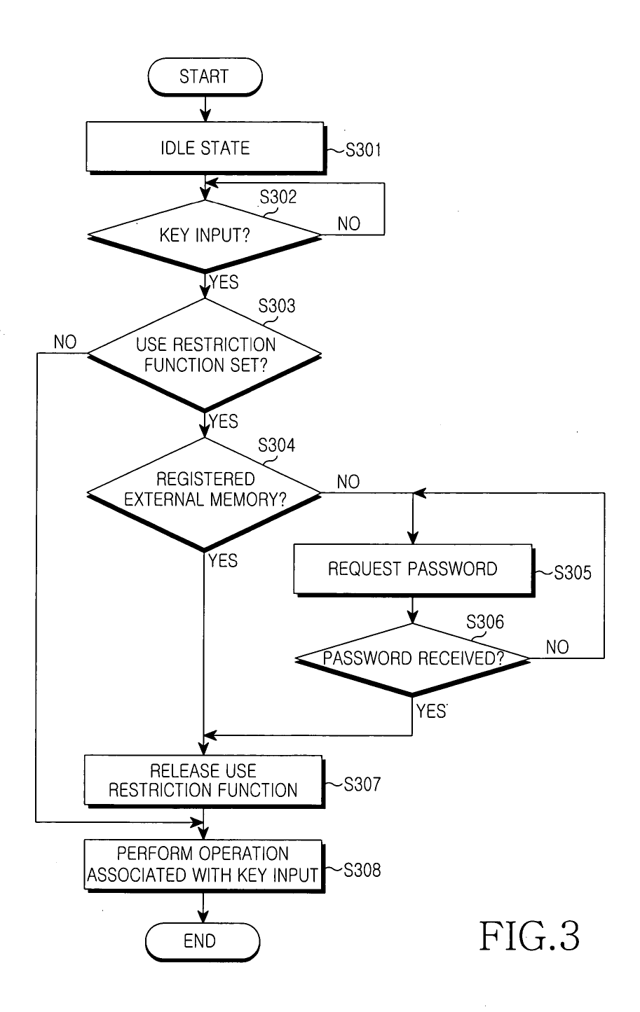

An operation for controlling functions of the exemplary portable terminal using the external memory 135 will now be described in greater detail with reference to FIGS. 2 and 3.

FIG. 2 is a flowchart illustrating an operation for controlling the power of the portable terminal depending on the insertion and ejection of the external memory 135 according to an embodiment of the present invention.

Referring to FIGS. 1 and 2, the portable terminal is in a power-off state in step S201. Upon insertion of the external memory 135 in the power-off state in step S202, the power switch (not shown) is switched to thereby supply power to the portable terminal in step S203. The function of the power supply mechanism of step S203 is similar to turning on the portable terminal by pressing a power key.

The controller 110 then determines whether the external memory 135 has a pre-registered ID in step S204. The user can set the ID directly. For example, the user can register the unique number of the external memory 135 as the ID when the external memory is initially inserted.

In step S207, upon detection of the ID, the controller 110 boots the portable terminal and transitions the portable terminal to an idle mode.

Alternatively, if the pre-registered ID is not detected from the external memory 135 in step S204, the controller 10 outputs a message prompting the user to enter a password in order to identify the user in step S205. The message can be output as a text message on the display 160 or as a voice message through the audio processor 125.

The controller 110 then determines whether a predetermined password has been received in step S206.

Upon receipt of the predetermined password, the controller 110 boots the portable terminal and transitions the portable terminal to the idle state in step S207. If the predetermined password has not been received, the controller 110 may turn off the portable terminal. Preferably, if a wrong password has been received over a predetermined number of times (for example, three or more times), the controller 110 turns off the portable terminal.

As described above, the procedure for turning on the portable terminal based upon the insertion and ejection of the external memory 135, can be set or released by a menu on the portable terminal.

FIG. 3 is a flowchart illustrating an operation for controlling the use restriction function of the portable terminal according to an embodiment of the present invention.

Referring to FIGS. 1 and 3, the portable terminal is placed in an idle state in step S301. Upon insertion of the external memory 135 while in the idle state, the controller 110 determines whether a predetermined key has been pressed in step S302. The key can be a key for entering a digit or character, the Menu key, the Send key, the key designated for capturing an image, the OK key, or a short key for messaging or dialing.

Upon input of the key, the controller 110 determines whether the portable terminal has been set to the use restriction function in step S303. As described above, the use restriction function can be one of a privacy protection function, outgoing call restriction function, and incoming call restriction function. It can be preset according to a user selection.

If the use restriction function has not been set, the controller 110 performs an operation associated with the pressed key in step S308.

Alternatively, if the use restriction function has been set, the controller 110 then determines whether the inserted external memory 135 has already been registered, for example, whether it has a pre-registered ID or a unique number registered in step S304.

If the external memory 135 has already been registered, the controller 110 releases the portable terminal from the use restriction state in step S307.

In step S308, the controller 110 then controls the portable terminal to perform the operation associated with the pressed key.

If the external memory 135 has not been registered in step S304, the controller 110 outputs a message prompting the user to enter a password to identify the user in step S305. The message can be output as a text message on the display 160 or as a voice message through the audio processor 125.

In step S306, the controller 110 then determines whether a predetermined password has been received.

Upon receipt of the predetermined password, the controller 110 releases the portable terminal from the use restriction state in step S307, and controls the portable terminal to perform the operation associated with the pressed key in step S308.

Upon ejection of the external memory 135 during this procedure, the controller 110 may notify the user that the operation associated with the pressed key cannot be performed through the display 160. If the external memory 135 is ejected in the use restriction release state, the controller 110 may reset the use restriction function in the portable terminal.

In accordance with embodiments of the present invention as described above, control of the functions of a portable terminal according to the insertion and ejection of an external memory expands the use of the external memory according to a user setting, aside from data storage functions.

While the invention has been shown and described with reference to certain preferred embodiments thereof, it will be understood by those skilled in the art that various changes in form and details may be made therein without departing from the spirit and scope of the invention as defined by the appended claims.

1. A method of controlling a portable terminal using an external memory, comprising the steps of:
turning on a portable terminal upon insertion of an external memory while in a power off state;
detecting a pre-registered identifier (ID) associated with the external memory upon power-on; and
booting the portable terminal upon detection of the ID in the external memory.

2. The method of claim 1, further comprising the step of setting the power-on function of the portable terminal upon the insertion of the external memory according to a user request.

3. The method of claim 1, further comprising the steps of:
requesting input of a predetermined password if the pre-registered ID is not detected; and
booting the portable terminal if the predetermined password is received.

4. The method of claim 3, further comprising the step of turning off the portable terminal if the password is not received.

5. A method of controlling a portable terminal using an external memory, comprising the steps of:
determining whether a use restriction function has been set upon a key input after insertion of an external memory in a portable terminal;
determining whether the external memory has been registered when the use restriction function has been set; and
releasing the use restriction function and performing an operation associated with the key input if the external memory has been registered.

6. The method of claim 5, further comprising the step of notifying a user that the operation associated with the key input cannot be performed upon ejection of the external memory.

7. The method of claim 6, further comprising the step of resetting the use restriction function after the operation associated with the key input is performed.

8. The method of claim 5, further comprising the step of setting the use restriction function of the portable terminal in response to a user request.

9. The method of claim 5, wherein the use restriction function is one of a privacy protection function, an outgoing call restriction function, and an incoming call restriction function.

10. The method of claim 5, further comprising the steps of:
requesting input of a predetermined password if the external memory has not been registered for providing an ID; and
performing the operation associated with the key input if the predetermined password is received.
